(19) United States
(12) Patent Application Publication
(10) Pub. No.: US 2008/0140590 A1
(43) Pub. Date: Jun. 12, 2008

(54) PROCESS CONTROL INTEGRATION SYSTEMS AND METHODS

(75) Inventor: Hsueh-Chi Shen, Hsinchu City (TW)

Correspondence Address: THOMAS, KAYDEN, HORSTEMEYER & RISLEY LLP, 600 GALLERIA PARKWAY, 15TH FLOOR, ATLANTA, GA, 30339, US

(73) Assignee: TAIWAN SEMICONDUCTOR MANUFACTURING CO., LTD., Hsin-Chu (TW)

(21) Appl. No.: 11/609,368

(22) Filed: Dec. 12, 2006

(51) Int. Cl. G06F 15/18; G06F 17/00

(52) U.S. Cl. 706/12; 700/96

(57) ABSTRACT

Systems of process control integration are provided. An embodiment of a system of process control integration comprises multiple process control systems (PCSs) and a supervisor controller. Each PCS calculates at least one process parameter based on at least one process model, a process target and an acceptable range. The supervisor controller couples to and coordinates the PCSs. A semiconductor fabrication operation is performed on a wafer based on the process parameter.

### BACKGROUND

The invention relates to semiconductor manufacturing, and more particularly, to systems and methods for process control integration.

A conventional semiconductor factory typically comprises fabrication tools appropriate for semiconductor wafers undergoing various processes, such as photolithography, chemical-mechanical polishing, or chemical vapor deposition. During manufacture, the semiconductor wafer passes through a series of process steps performed by various fabrication tools. In the production of an integrated semiconductor product, for example, the semiconductor wafer passes through up to 600 process steps. Automated production costs are greatly influenced by how efficiently manufacturing processes can be monitored or controlled to ensure that the ratio of defect-free products to the overall number of products manufactured (i.e., yield ratio) achieves as great a value as possible.

### SUMMARY

Systems of process control integration are provided. An embodiment of a system of process control integration comprises multiple process control systems (PCSs) and a supervisor controller. Each PCS calculates at least one process parameter based on at least one process model, a process target and an acceptable range. The supervisor controller couples to and coordinates the PCSs. A semiconductor fabrication operation, performed on a wafer, is based on at least one process parameter.

An embodiment of process control integration comprises: first and second fabrication tools; a post-process metrology tool subsequent to the first fabrication tool; a PCS associated with the second fabrication tool, and a supervisor controller. The first fabrication tool performs a first semiconductor fabrication operation on a wafer. The post-process metrology tool generates feedback data in response to the result of the first semiconductor fabrication operation. The supervisor controller couples to the first fabrication tool, the second fabrication tool, the post-process metrology tool and the PCS to acquire feedback data from the post-process metrology tool. A process target and an acceptable range are determined based on a device model and the feedback data. An optimization execution instruction with the determined process target and acceptable range is issued to the PCS directing it to calculate at least one process parameter based on at least one process model, the determined process target and the acceptable range.

Methods of process control integration are provided. An embodiment of a method of process control integration, performed by a supervisor controller coordinating multiple PCSs, comprises the following steps. An optimization execution instruction with a process target and an acceptable range is issued to one of the PCSs associated with a fabrication tool in order to acquire at least one process parameter. The process parameter is calculated by the PCS associated with the fabrication tool based on the process target and the acceptable range.

### BRIEF DESCRIPTION OF THE DRAWINGS

The invention can be more fully understood by reading the subsequent detailed description and examples with references made to the accompanying drawings, wherein:

FIG. 1 is a diagram of an embodiment of a process control integration system;

FIG. 2 is a diagram showing an exemplary material flow of a semiconductor manufacturing process supporting R2R control;

FIG. 3 is a diagram of an embodiment of a hardware environment of a supervisor controller;

FIG. 4a is a diagram of an exemplary etching model depicting how many nms of material depth are theoretically removed from the surface at various time durations;

FIG. 4b is a diagram of an exemplary revised etching model depicting how many nms of material depth are theoretically removed from the surface at various time durations;

FIG. 5 is a sequence diagram for coordinating metrology tools, fabrication tools and PCSs;

FIG. 6 is a diagram illustrating a scenario coordinating two PCSs when wafers or wafer lots undergo two process stages for forming gates thereon;

FIG. 7 is a diagram of an exemplary gate model (i.e. a device model) describing the theoretical relationships between opening widths and dosages.

### DETAILED DESCRIPTION

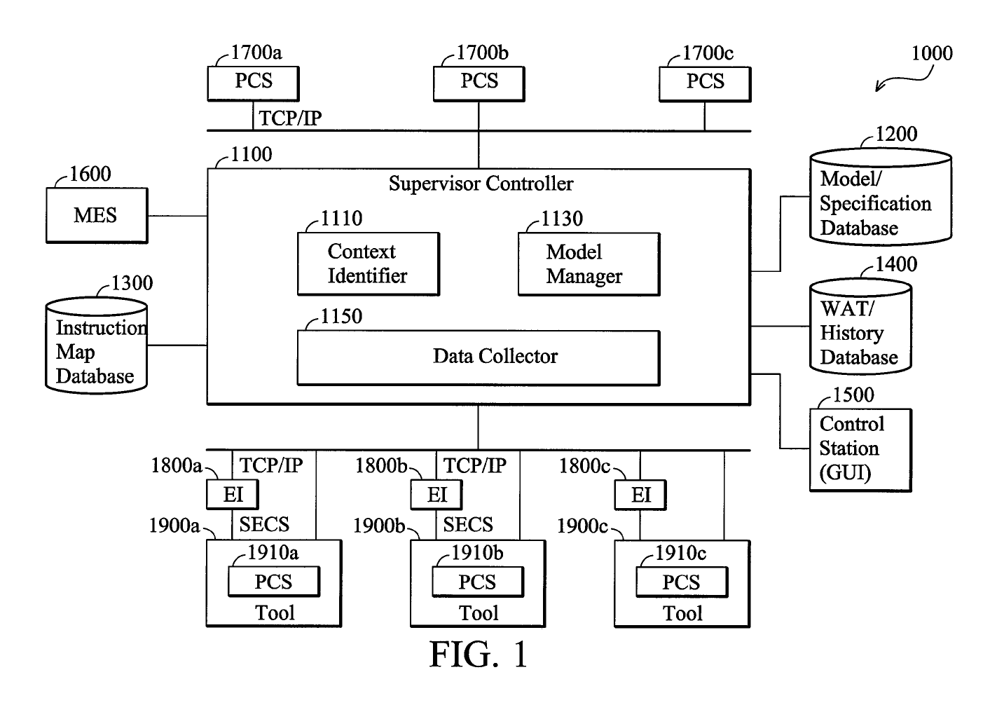

FIG. 1 is a diagram of an embodiment of a process control integration system 1000 comprising a supervisor controller 1100, a model/specification database 1200, an instruction map database 1300, a wafer acceptance test (WAT)/specification database 1400, a control station preferably including a graphical user interface (GUI) 1500, a manufacturing execution system (MES) 1600, process control systems (PCSs) 1700a to 1700c and 1910a to 1910c, and tools 1900a to 1900c. The tool may be a fabrication tool or a metrology tool. Fabrication tools typically perform a single wafer fabrication task on the wafers in a given lot. A fabrication tool may, for example, perform patterning, forming, doping or heat treatment operations. Fabrication tools may embed PCSs. The embedded PCSs are capable of communicating with external apparatuses, such as the supervisor controller 1100, the MES 1600 and similar. It is to be understood that PCSs may be external systems outside of the fabrication tools. The PCSs optimize operation parameters for a process stage such as chemical vapor deposition (CVD), etching, implanting, or similar, based on multiple process models, input targets and tolerance ranges. One or more wafers processed by a fabrication tool are sent to a metrology tool to acquire metrology data. The metrology data corresponds to a variety of physical or electrical characteristics of the devices formed on the wafers. Metrology data may comprise line widths, trench depths, sidewall angles, thicknesses, resistance, and similar. During integrated circuit fabrication, for example, various test structures are fabricated on a wafer to extract information on the process and device performance for fault analysis. WAT data is generated by electrical measurements of these test structures, such as resistance, voltage or the others, after the entire fabrication process is complete. A line width is measured using an electron beam (e-beam). The e-beam measurement may also be CD scanning electron microscope (CD-SEM) measurement. The metrology data may be stored in the WAT/history database unit 1400. The model/specification database 1200, instruction map database 1300, WAT/history database 1400, and/or control station 1500 may be integrated into the supervisor controller 1100, or may be resident in isolated computer hosts (servers). The fabrication tool or metrology tool may communicate with the supervisor controller 110 via an equipment interface (EI), such as 1800a, 1800b or 1800c. The EIs comprise software services compliant with 300 mm semiconductor equipment and material international (SEMI) E133 standards specifying transport protocol, message format and functionality. The SEMI E133 standard defines inline PCS architecture interfaces for run-to-run (R2R) control, FDC (fault detection and classification) and SPC (statistical process control) capabilities. The,top-level controller, supervisor controller 1100, monitors, manages and coordinates various types of PCSs to integrate process control. Note that the PCSs may be provided by various tool vendors. The supervisor controller 1100 may directly communicate with PCSs and EIs via TCP/IP (Transmission Control Protocol/Internet Protocol). The EI may communicate with tools via SECS (SEMI Equipment Communications Standard) protocol.

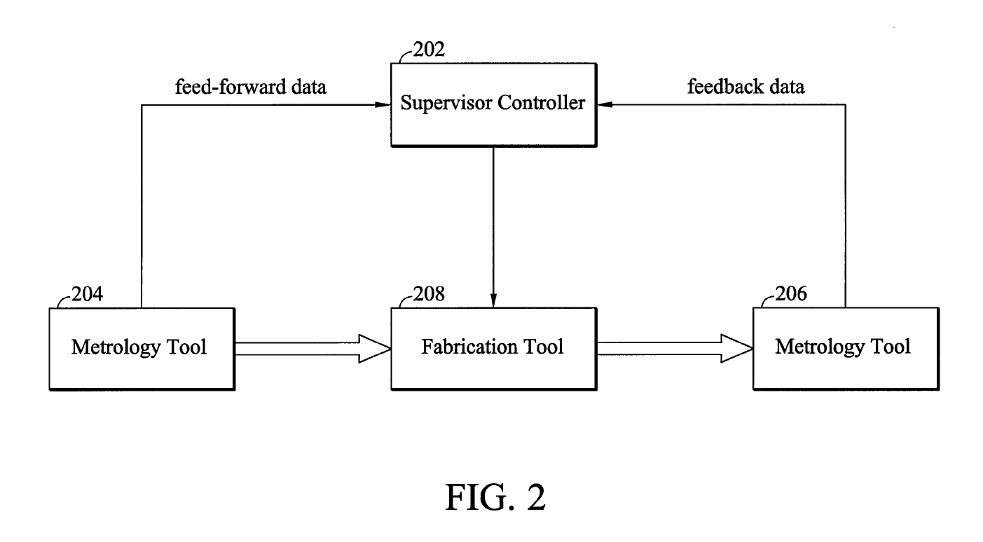

FIG. 2 is a diagram showing an exemplary material flow of a semiconductor manufacturing process supporting R2R control. This diagram shows how a supervisor controller 202 supports a tvpical R2R control scenario. The supervisor controller 202 receives feed-forward and feedback data and calculates process parameters in process recipes. Two metrology tools, a pre-process metrology tool 204 and a post-processing metrology tool 206 are provided. The pre-process metrology tool 204 performs a measurement on a material prior to processing in a fabrication tool 208 and sends the measurement, as feed-forward data, to the supervisor controller 202. The supervisor controller 202 adjusts process recipes for the fabrication tool 208 based on the feed-forward data, referred to as feed-forward control. After processing, a transport system (not shown) transports wafers from the fabrication tool 208 to the post-process metrology tool 206 to measure post-process data which is sent to the supervisor controller 202 as feedback data. The feedback data will be utilized to adjust fabrication of the next run of wafers or wafer lots, referred to as feedback control.

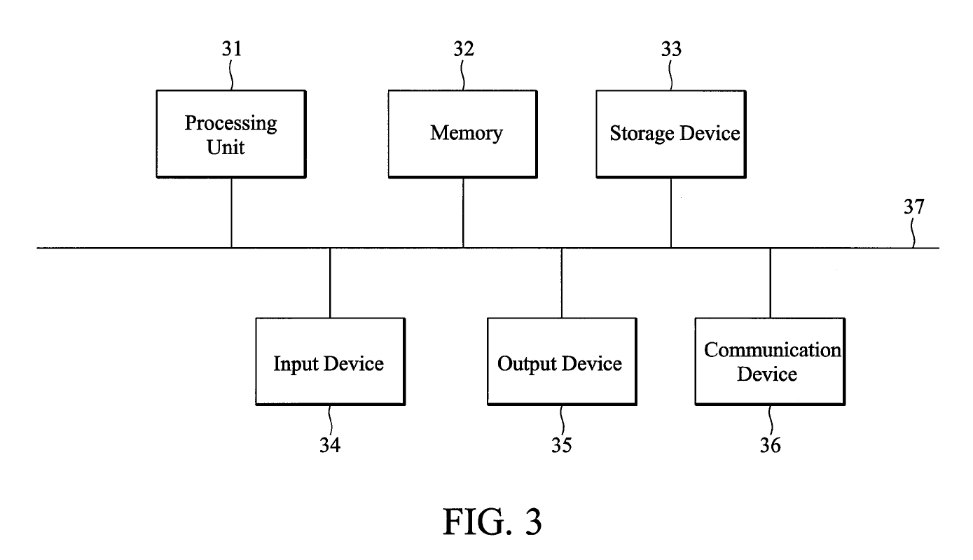

FIG. 3 is a diagram of an embodiment of a hardware environment of the supervisor controller 1100. The hardware environment of FIG. 3 includes a processing unit 31, a memory 32, a storage device 33, an input device 34, an output device 35 and a communication device 36. The processing unit 31 is connected by buses 37 to the memory 32, storage device 33, input device 34, output device 35 and communication device 36 based on Von Neumann architecture. There may be one or more processing units 31, such that the processor of the computer comprises a single central processing unit (CPU), a micro processing unit (MPU) or multiple processing units, commonly referred to as a parallel processing environment. The memory 32 is preferably a random access memory (RAM), but may also include read-only memory (ROM) or flash ROM. The memory 32 preferably stores program modules executed by the processing unit 31 to perform process control integration functions. Generally, program modules include routines, programs, objects, components, or others, that perform particular tasks or implement particular abstract data types. Moreover, those skilled in the art should understand that at least some embodiments may be practiced with other computer system configurations, including hand-held devices, multiprocessor-based, microprocessor-based or programmable consumer electronics, network PCs, minicomputers, mainframe computers, and the like. Some embodiments may also be practiced in distributed computing environments where tasks are performed by remote processing devices linked through a communication network. In a distributed computing environment, program modules may be located in both local and remote memory storage devices based on various remote access architecture such as DCOM, CORBA, Web object, Web Services or other similar architectures. The storage device 33 may be a hard drive, magnetic drive, optical drive, a portable drive, or nonvolatile memory drive. The drives and their associated computer-readable media (if required) provide nonvolatile storage of computer-readable instructions, data structures, program modules and experiment lot processing records. The storage device 33 may comprise a database management system, an object base management system, a file management system, or others, to store a model/specification database (e.g. 1200 of FIG. 1), a WAT/history database (e.g. 1400 of FIG. 1) and an instruction map (e.g. 1300 of FIG. 1).

Referring to FIG. 1, the MES 1600 may be an integrated computer system representing the methods and tools used to accomplish semiconductor device production. For example, the primary functions of MES may include collecting manufacturing data in real time, organizing and storing the manufacturing data in a centralized database, work order management, fabrication tool management and process management. Examples of MES include Promis (Brooks Automation Inc. of Massachusetts), Workstream (Applied Materials, Inc. of California), Poseidon (IBM Corporation of New York), and Mirl-MES (Mechanical Industry Research Laboratories of Taiwan). Each MES may have a different application area. For example, Mirl-MES may be used in applications involving packaging, liquid crystal displays (LCDs), and printed circuit boards (PCBs), while Promis, Workstream, and Poseidon may be used for IC fabrication and thin film transistor LCD (TFT-LCD) applications.

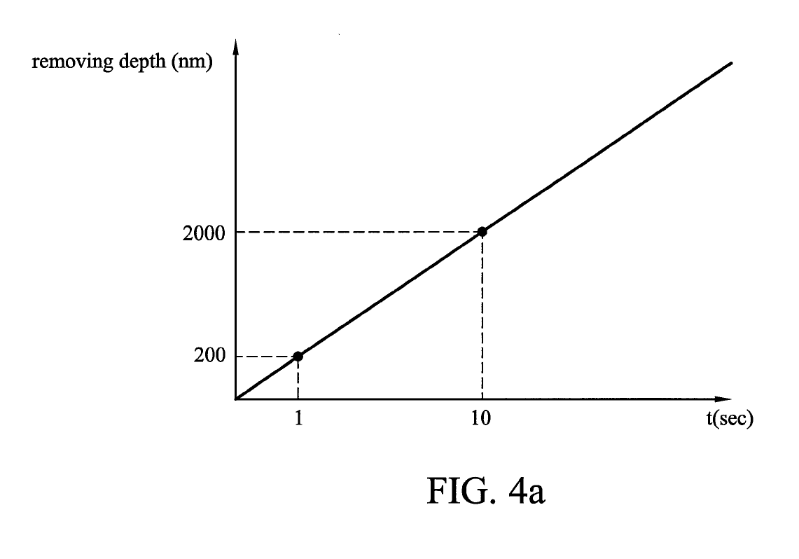

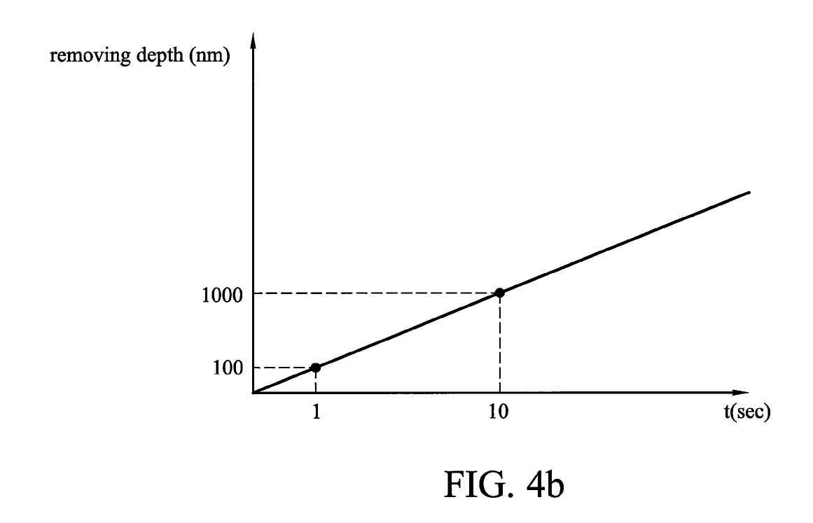

The supervisor controller 1100 primarily contains three software modules such as context identifier 1110, model manager 1130 and data collector 1150. The data collector 1150 may collect feed-forward and feedback data from metrology tools, and health indices from fabrication and metrology tools, such as gas flow rate, prediction error, metrology missing, metrology delay, and similar, and store the collected data in the WAT/history database 1400. It is to be understood that the feed-forward and feedback data, and health indices may alternately be retrieved from the MES 1600. The model manager 1130 manages process models for various fabrication tools. Each process model describes relationships between input processing recipes and output results, typically represented as y=f(x), x representing input processing recipes and y representing output results. For example, in a plasma chamber, substrate etching is achieved by exposing a substrate to ionized gas compounds (plasma) under vacuum. The etching process begins when the gases are conveyed into a plasma chamber. The radio frequency (RF) ionizes the gases tuned by a particular process parameter to control the direction and energy of ion bombardment of a wafer. During the etching process, the plasma reacts chemically with the surface of a wafer to remove material not covered by a photoresist mask. Trim time (i.e. etching duration) is also tuned by another process parameter to remove material of a particular depth. FIG. 4a is a diagram of an exemplary etching model depicting how many nms of material depth are theoretically removed from the surface at various time durations. Referring to FIG. 1, when the supervisor controller 1100 detects that the chamber is passivated, the etching model may be updated by the model manager 1130 according to previously collected feedback data, and/or health indices. FIG. 4b is a diagram of an exemplary revised etching model depicting how many nms of material depth are theoretically removed from the surface at various time durations. The supervisor controller 1100 subsequently instructs a relevant PCS to update the old etching model with the new one.

Each run of wafers or wafer lots is associated with a context identifier comprising a process identifier and a control identifier for each process stage such as chemical mechanical polishing (CMP), etching, implanting, or similar. The process or control identifier may be represented by alphanumeric characters, alphabetic characters, or the combinations. Each process identifier comprises information regarding what technology, product, tool group, tool type, chamber, recipe, layer, reticle, sequence, equipment recipe, stage identifiers, or combinations thereof, a process stage is associated with. The technology may be the 0.25 μm, 0.18 μm, 90 nm, 65 nm, 45 nm technology, or the like. The product (i.e. part number) may be a static random access memory (SRAM), a synchronized dynamic random access memory (SDRAM), a graphics chip, or similar, for a particular customer. The reticle may represent a particular mask. For example, one process identifier may associate with a particular product, tool group and a process stage, and another process identifier may only associate with a particular chamber. It is to be understood that each process model is also associated with a particular process identifier. Therefore, the model manager 1130 can acquire a relevant process model of a process stage for any run of wafers or wafer lots by matching the associated process identifiers. The control identifier indicates which PCS a particular process stage is monitored and controlled by.

The instruction map database 1300 stores information comprising supervisor controller 1100 instructions issued thereby to a particular PCS at specific times. Such instructions may be a model update instruction, an optimization execution instruction, and/or a compensation instruction. The model update instruction is issued to direct the corresponding PCS to update a process model. The optimization execution instruction is issued to direct the corresponding PCS to calculate the optimum process parameters for a process recipe based on the stored process models. The compensation instruction is issued to direct the PCS to perform an operation for compensating wafers or wafer lots when the supervisor controller 1100 detects that the evaluated offset for incoming wafers or wafer lots away from a predetermined target. Note that, when receiving the compensation instruction, the PCS acquires feed-forward data from a pre-process metrology tool, evaluates the offset for the incoming wafers or wafer lots according to the acquired feed-forward data and the predetermined target, calculates process parameters of a process recipe for compensating the evaluated offset based on the stored process models and instructs a fabrication tool to perform the calculated process parameters.

The supervisor controller 1100, at specific times, performs relevant DC plans to acquire feedback data measured by a post-process metrology tool, execution recipe performed by a fabrication tool, and/or health indices of a fabrication tool from the corresponding PCS.

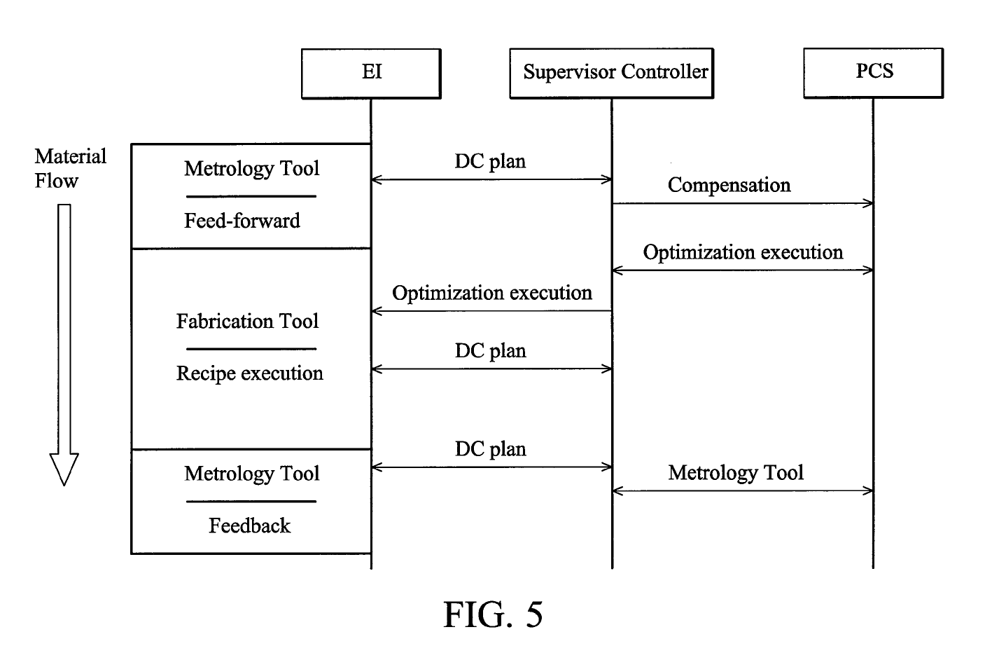

FIG. 5 is a sequence diagram for coordinating metrology tools, fabrication tools and PCSs. When undergoing a particular process stage, wafers or wafer lots of each run are typically and sequentially transported to a pre-process metrology tool, a fabrication tool and a post-process metrology tool, in order to measure feed-forward data, complete the process stage and measure feedback data. It is to be understood, in some process stages, wafers or wafer lots of each run may not be transported to a pre-process metrology tool to acquire feed-forward data. A supervisor controller (e.g. 1100 of FIG. 1) performs a DC plan to collect feed-forward data after measuring wafers or wafer lots by a pre-process metrology tool. It is determined, according to the collected feed-forward data, whether a compensation operation is required. If so, the supervisor controller determines a fabrication tool in a tool group and issues a compensation instruction to a PCS associated with the determined fabrication tool to compensate the wafers or wafer lots. When detecting that the height of the formed thin film is greater than a predetermined target, for example, the supervisor controller determined a CMP tool in a tool group and issues a compensation instruction to a PCS associated with the determined CMP tool. After that, the determined PCS acquires the height of the formed thin film from a pre-process metrology tool, evaluates the offset for the incoming wafers or wafer lots, calculates polishing time for compensating the evaluated offset based on the stored process models and instructs the associated CMP tool to perform CMP for the calculated polishing time.

As wafers or wafer lots prepare to undergo a process stage, the supervisor controller determines a fabrication tool in a tool group and issues an optimization execution instruction with a given target and an acceptable range to a PCS associated with the determined fabrication tool. The PCS calculates (or optimizes) process parameters based on stored process models and the received target and acceptable range and transmits the calculated process parameters to the supervisor controller. The supervisor controller issues an operation execution instruction with the process parameters to the determined fabrication tool instructing the fabrication tool to execute a fabrication operation such as CVD, etching, implanting or similar, according to the process parameters. As wafers or wafer lots prepare to undergo an etching process, for example, the supervisor controller issues an optimization execution instruction with information indicating that a depth of ten ±one nms (a predetermined target with an acceptable range) of material shall be removed from the surface to a PCS. The PCS calculates a trim time based on the stored etching model (as in FIG. 4a or 4b) and the received information, and transmits the calculated trim time to the supervisor controller. It is to be understood that the PCS embeds optimization logics provided by a tool vendor for calculating trim times based on at least the stored etching model, a predetermined target and an acceptable range. During fabrication, the supervisor performs a DC plan to collect and store fabrication details, and/or health indices of the fabrication tool.

The supervisor controller performs a DC plan to collect feedback data after measuring wafers or wafer lots by a post-process metrology tool. It is determined whether a model update is required according to the collected feedback data. If so, the supervisor controller issues a model update instruction with a new process model to the PCS in order to force the PCS to replace the original process model with the new one, or issues a model update instruction with the feedback data in order to force the PCS to regenerate a new process model according to the feedback data. When detecting that the removed height of the formed thin film is seven nms after etching, for example, the supervisor controller issues a model update instruction with a new etching model or feedback data to the PCS. The PCS subsequently replaces the original etching model with the new one. It is to be understood that the newly updated process model will be applied to wafers or wafer lots of the next run.

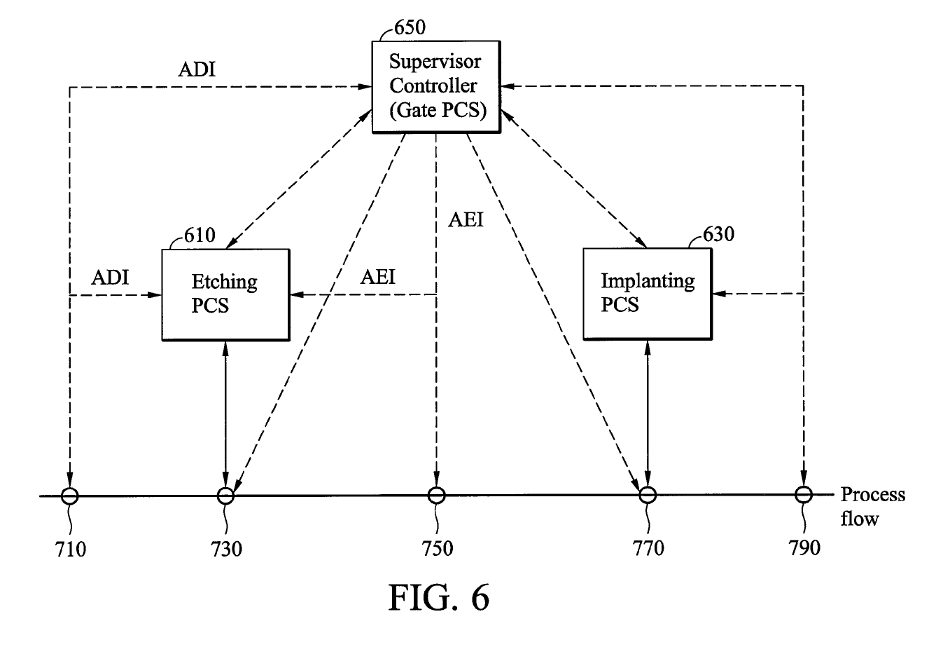

FIG. 6 is a diagram illustrating a scenario coordinating two PCSs when wafers or wafer lots undergo two process stages for forming gates thereon. An etching PCS 610 associates with an etching tool 730, and an implanting PCS 630 associates with an implanting tool 770. Before etching, wafers or wafer lots undergo an after-development inspection (ADI) for an etching operation by a pre-process metrology tool 710. The supervisor controller 650 performs a DC plan to acquire the ADI results (i.e. feed-forward data) from the pre-process metrology tool 710, determines an etching target and an acceptable range (e.g. a line width of ten ±one nm) according to the acquired ADI results and issues an optimization execution instruction with the determined etching target and acceptable range to the etching PCS 610 to acquire a trim time calculated by the etching PCS 610. It is to be understood that the supervisor controller may further store the acquired ADI results and trim time in a WAT/history database (e.g. 1400 of FIG. 1). The supervisor controller 650 issues an etching execution instruction with the acquired trim time to the etching tool 730 to instruct the etching tool 730 to perform an etching operation for the trim time. After etching, wafers or wafer lots undergo an after-etch inspection (AEI) for the etching operation by a post-process metrology tool 750. The supervisor controller 650 performs a DC plan to acquire the AEI results (i.e. feedback data) from the post-process metrology tool 750 and determines whether a model update is required according to the AEI results. If so, the supervisor controller 650 issues a model update instruction to the etching PCS 610 to replace the original process models. It is to be understood that the supervisor controller may further store the acquired AEI results in a WAT/history database (e.g. 1400 of FIG. 1) and new process models in a model/specification database (e.g. 1200 of FIG. 1).

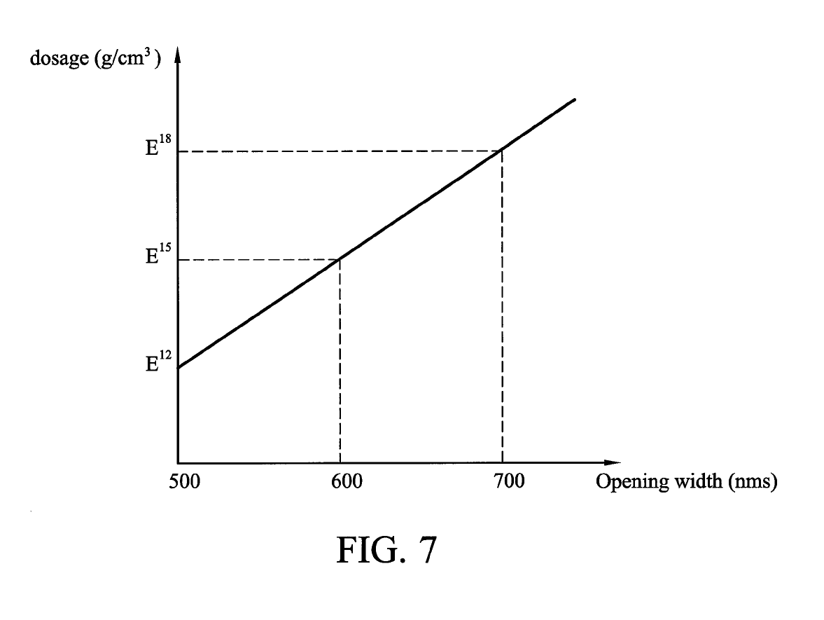

Furthermore, the supervisor controller 650 determines an implanting target and an acceptable range (e.g. a dosage of E^{15±1} g/cm³) based on the acquired AEI results (e.g. an opening width) and a device model for generating gates. FIG. 7 is a diagram of an exemplary gate model (i.e. a device model) describing the theoretical relationships between opening widths and dosages, being higher dosage with larger opening width. Note that the gate model may be updated when detecting that fabrication situation has altered, such as chamber passivation, or similar. The supervisor controller 650 issues an optimization execution instruction with the determined implanting target and acceptable range to the implanting PCS 630 to acquire relevant process parameters calculated by the implanting PCS 630, and issues an implanting execution instruction with the acquired process parameters to the implanting tool 770 in order to direct the implanting tool 770 to perform an implanting operation with the process parameters.

Process control integration systems and methods, or certain aspects or portions thereof, may take the form of program code (i.e., instructions) embodied in tangible media, such as floppy diskettes, CD-ROMS, hard drives, or any other machine-readable storage medium, wherein, when the program code is loaded into and executed by a machine, such as a computer, the machine becomes an apparatus for practicing the invention. The disclosed methods and systems may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing the invention. When implemented on a general-purpose processor, the program code combines with the processor to provide a unique apparatus that operates analogously to specific logic circuits.

Certain terms are used throughout the description and claims to refer to particular system components. As those skilled in the art will appreciate, semiconductor manufacturers may refer to a component by different names. This document does not intend to distinguish between components that differ in name but not function.

Although the invention has been described in terms of preferred embodiment, it is not limited thereto. Those skilled in the art can make various alterations and modifications without departing from the scope and spirit of the invention. Therefore, the scope of the invention shall be defined and protected by the following claims and their equivalents.

What is claimed is:

1. A system of process control integration comprising:
a plurality of process control systems (PCSs) respectively calculating at least one process parameter based on at least one process model, a process target and an acceptable range; and
a supervisor controller coupling to and coordinating the PCSs,
wherein a semiconductor fabrication operation is performed on a wafer based on the process parameter.

2. The system as claimed in claim 1 wherein the supervisor controller issues an optimization execution instruction with the process target and the acceptable range to one of the PCSs associated with a fabrication tool in order to acquire the process parameter.

3. The system as claimed in claim 2 wherein the supervisor controller issues an operation execution instruction with the acquired process parameter to the associated fabrication tool in order to direct the associated fabrication tool to perform the semiconductor fabrication operation on the wafer according to the acquired process parameter.

4. The system as claimed in claim 3 wherein the supervisor controller performs a data collection (DC) plan to acquire feed-forward data from a pre-process metrology tool prior to the associated fabrication tool and determines whether a compensation operation is required according the collected feed-forward data.

5. The system as claimed in claim 4 wherein, when determining that the compensation operation is required, the supervisor controller issues a compensation instruction to the PCS associated with the fabrication tool in order to direct the associated fabrication tool to perform the compensation operation on the wafer.

6. The system as claimed in claim 5 wherein, after receiving the compensation instruction, the PCS associated with the fabrication tool acquires the feed-forward data from the pre-process metrology tool, evaluates the offset for the wafer and directs the associated fabrication tool to compensate the evaluated offset for the wafer.

7. The system as claimed in claim 3 wherein the supervisor controller performs a data collection (DC) plan to acquire feedback data from a post-process metrology tool subsequent to the associated fabrication tool and determines whether model update is required according the collected feedback data.

8. The system as claimed in claim 7 wherein, when determining that model update is required, the supervisor controller issues a model update instruction with at least one new process model to the PCS associated with the fabrication tool in order to direct the PCS associated with the fabrication tool to update the original process model with the new process model.

9. The system as claimed in claim 7 wherein, when determining that model update is required, the supervisor controller issues a model update instruction to the PCS associated with the fabrication tool in order to direct the PCS associated with the fabrication tool to regenerate at least one new process model and update the original process model with the newly generated process model.

10. A system of process control integration comprising:
a first fabrication tool performing a first semiconductor fabrication operation on a wafer;
a second fabrication tool;
a post-process metrology tool subsequent to the first fabrication tool, generating feedback data in response to the fabrication result of the first semiconductor fabrication operation;
a process control system (PCS) associated with the second fabrication tool; and
a supervisor controller coupling to the first fabrication tool, the second fabrication tool, the post-process metrology tool and the PCS, acquiring the feedback data from the post-process metrology tool, determining a process target and an acceptable range based on a device model and the feedback data, and issuing an optimization execution instruction with the determined process target and acceptable range to the PCS in order to direct the PCS to calculate at least one process parameter based on at least one process model, the determined process target and the acceptable range.

11. The system as claimed in claim 10 wherein the supervisor controller acquires the calculated process parameter from the PCS and issues an operation execution instruction with the acquired process parameter in order to direct the second fabrication tool performs a second semiconductor fabrication operation on the wafer based on the acquired process parameter.

12. A method of process control integration, performed by a supervisor controller coordinating a plurality of process control systems (PCSs), comprising:
issuing an optimization execution instruction with a process target and a acceptable range to one of the PCSs associated with a fabrication tool in order to acquire at least one process parameter,
wherein the process parameter is calculated by the PCS associated with the fabrication tool based on the process target and the acceptable range.

13. The method as claimed in claim 12 further comprising issuing an operation execution instruction with the acquired process parameter to the associated fabrication tool in order to direct the associated fabrication tool to perform a semiconductor fabrication operation on a wafer according to the acquired process parameter.

14. The method as claimed in claim 13 further comprising:
performing a data collection (DC) plan to acquire feed-forward data from a pre-process metrology tool prior to the associated fabrication tool; and
determining whether a compensation operation is required according the collected feed-forward data.

15. The method as claimed in claim 14 further comprising, when determining that the compensation operation is required, issuing a compensation instruction to the PCS associated with the fabrication tool in order to direct the associated fabrication tool to perform the compensation operation on the wafer.

16. The method as claimed in claim 15 wherein, after receiving the compensation instruction, the PCS associated with the fabrication tool acquires the feed-forward data from the pre-process metrology tool, evaluates the offset for the wafer and directs the associated fabrication tool to compensate the evaluated offset for the wafer.

17. The method as claimed in claim 13 further comprising:
performing a data collection (DC) plan to acquire feedback data from a post-process metrology tool subsequent to the associated fabrication tool; and
determining whether model update is required according the collected feedback data.

18. The method as claimed in claim 17 further comprising, when determining that model update is required, issuing a model update instruction with at least one new process model to the PCS associated with the fabrication tool in order to direct the PCS associated with the fabrication tool to update the original process model with the new process model.

19. The method as claimed in claim 17 further comprising, when determining that model update is required, issuing a model update instruction to the PCS associated with the fabrication tool in order to direct the PCS associated with the fabrication tool to regenerate at least one new process model and update the original process model with the newly generated process model.
